(19) United States
(12) Patent Application Publication
(10) Pub. No.: US 2007/0105969 A1
(43) Pub. Date: May 10, 2007

(54) Multi-density flexible foam

(76) Inventors: Kenneth Warnshuis, Adrian, MI (US); Victor Gandara, Adrian, MI (US); Felipe R. Terrones, Adrian, MI (US)

Correspondence Address: Miller, Canfield, Paddock and Stone P.L.C.;c/o Robert Kelley Roth, Suite 2500, 150 West Jefferson Ave, Detroit, MI, 48226, US

(21) Appl. No.: 11/449,270

(22) Filed: Jun. 8, 2006

Related U.S. Application Data
(63) Continuation-in-part of application No. 11/272,358, filed on Nov. 10, 2005.

(51) Int. Cl. C08J 9/16

(52) U.S. Cl. 521/56

(57) ABSTRACT

A multi-density foam material and method of manufacturing thereof comprises combining in a mold a polyol mixture with an isocyanate mixture in a ratio of about 0.2 to 1.0 parts by weight of the polyol mixture, with expandable beads in an amount of about 0.1 to 1.5 parts per weight of the polyol mixture. The polyol mixture and the isocyanate mixture react exothermically to form a flexible foam, and heat generated from the reaction causes the expandable beads to at least partially expand, but the mold is at a temperature below that where significant expansion of the expandable beads occurs. The resulting foam material has a center with a first density, and an exterior edge with a second density different than the first density.

### RELATED APPLICATION

This application is a continuation-in-part which claims priority benefit of U.S. utility patent application Ser. No. 11/272,358 filed on Nov. 10, 2005.

### FIELD OF THE INVENTION

This invention relates to multi-density foams, and more particularly to multi-density foams suitable for use in the formation of foam objects.

### BACKGROUND OF THE INVENTION

Flexible foam objects are used in many cushioning applications, including furniture, bedding, steering wheels, instrument panels, console box lids and glove box lids, seating, carpet underlays, armrests and headrests, etc. Flexible foams comprise a range of foams, including integral skin foams, slab stock (used extensively in furniture foams and bedding), molded flexible foams, and viscoelastic foams (used in bedding, pillows and some automotive foam applications). Generally these foams are not structural members and they resiliently yield to pressure.

Flexible polyurethane foams can be formed from a reaction of a polyol mixture and an isocyanate. A broad range of properties and characteristics have been made for polyurethanes (from rigid polyurethane foams to flexible polyurethane foams) principally by varying components of the polyol mixture and the foaming equipment used. For flexible polyurethane foams, long chain triols and water may be used as components of the polyol mixture. A wide variety of isocyanates can be used to make flexible polyurethane foam, but the most common isocyanates are toluene diisocyanate (TDI) and polymeric isocyanate (MDI). When the aforementioned polyol mixtures are reacted with the aforementioned isocyanates, wide-meshed elastic networks of ruptured cell walls are formed, creating a web of elastic strands.

Alternate polyol mixtures are used to create rigid polyurethane foams. These typically include branched starting materials such as low molecular weight alcohols with three or more reactive centers (OH groups). Rigid polyurethane foams have a high density of covalent cross-linking, and a high hydroxyl value range (used as a measure of the concentration of isocyanate-reactive hydroxyl groups per unit weight of the polyol). Rigid polyurethane foams have a closed cell structure with discrete foam cells separated from each other by a polymer matrix. Rigid foams are typically not used where a cushioning material is desired. By contrast, flexible polyurethane foams generally have an open cell structure, wherein the cell wall membranes rupture and leave polymer material struts which form a web of elastic strands.

Several patents discuss use of expandable polymer materials mixed with polyurethanes. U.S. Pat. No. 3,277,026 to Newnham et al discloses an upholstery foam material comprising latex rubber or polyurethane (rigid or flexible) with polystryrene granules. This foam material is made in an open mold or paper mold, and produces a material having uniform density. U.S. Pat. No. 3,503,840 to Parrish discloses a cushioning structure especially useful as a carpet underlay comprising a resilient open-celled foam and gas-inflated organic polymeric cellular material formed in an open mold and to provide a structure with an overall low density. U.S. Pat. No. 3,667,797 to Rubens discloses a composite low density flexible foam comprising a flexible polyurethane and a polyvinyl aromatic hydrocarbon formed in a paperboard box mold.

U.S. Pat. No. 6,727,290 to Roth discloses a rigid polyurethane formed from a mixture of a polyol and an isocyanate. A small amount of expandable beads are added to the mixture before it cures. The beads expand and take up some of the space which would otherwise be occupied with polyurethane. However, such rigid polyurethanes have structural properties where they are designed to withstand relatively large amounts of loading (e.g., rigid polyurethanes may be used as plastic pallets). To maintain these properties, rigid foams require relatively large amounts of isocyanates and relatively low amounts of beads, to preserve density and maintain rigid foam impact durability. Further, with rigid polyurethane foams containing expandable beads as disclosed in Roth et al, gas released from the beads is trapped by a rigid polyurethane matrix and forms a bubble. The beads partial melt due to relatively high heat of reaction and form a coating around the bubble. The bubble acts to keep the rigid polyurethane density low and to enhance impact resistance. None of the references mentioned above provide a multi-density flexible polyurethane foam.

Flexible polyurethane foams may be used in headrests, and have been used in production in motor vehicles for many years. The flexible foam headrest provides both a convenient place to rest an operator's head and also provides protection in the event of sudden changes in acceleration of the motor vehicle. Headrests also often are adjustably mounted to a seat to provide comfort adjustment. Generally, such headrests include cloth covered headrests and integral skin foam headrests. With cloth covered headrests, a flexible foam or cushion like interior is shrouded by a cloth. Integral skin foam headrests have a thin exterior integral skin region (often made with a urethane paint applied to a mold surface) and an interior region having a high degree of foaming. Known flexible foam headrests are subject to competing design constraints. On the one hand it is desirable to make the foam headrest comfortable for the occupant. On the other hand it is desirable to increase the stiffness of the headrest to reduce a whiplash effect during sudden changes in acceleration of a motor vehicle. It would be highly desirable to provide a flexible foam material which has multiple densities and to provide an improved flexible foam object with optimized stiffness characteristics.

### SUMMARY OF THE INVENTION

In accordance with a first aspect, a multi-density flexible foam is disclosed which comprises combining in a mold a polyol mixture with an isocyanate mixture and expandable beads. The polyol mixture and the isocyanate mixture react exothermically to form a flexible foam, and heat generated from the reaction causes the expandable beads to at least partially expand, but the mold is at a temperature below that where significant expansion of the expandable beads occurs. The resulting foam material has a center with a first density, and an exterior edge with a second density different than the first density. In accordance with another aspect, the edge of the resulting foam material is heated to a temperature below that where significant expansion of the expandable beads occurs.

From the foregoing disclosure and the following more detailed description of various preferred embodiments it will be apparent to those skilled in the art that the present invention provides a significant advance in the technology of flexible foam parts. Particularly significant in this regard is the potential the invention affords for providing a high quality flexible foam part with varying density. Additional features and advantages of various preferred embodiments will be better understood in view of the detailed description provided below.

### BRIEF DESCRIPTION OF THE DRAWINGS

FIG. 1 is a perspective view of a mold halves suitable for making a multi-density foam material in accordance with a preferred embodiment.

FIG. 2 is a perspective view of a cloth covered headrest formed from a multi-density foam material in accordance with a preferred embodiment.

FIG. 3 is a perspective view of an integral skin headrest formed from a multi-density foam material in accordance with a preferred embodiment.

FIG. 4 is a cross section view of the headrest of FIG. 3, showing the foam material having a first density at a center and an edge with a second density less than the first density.

FIG. 5 is a view of a headrest assembled to a motor vehicle seat subjected to a vertical load.

FIG. 6 is a graph showing load vs. displacement for a headrest subject to vertical load.

FIG. 7 is a view of a headrest assembled to a motor vehicle seat subjected to an offset load.

FIG. 8 is a graph showing load vs. displacement for a headrest subject to an offset load.

It should be understood that the appended drawings are not necessarily to scale, presenting a somewhat simplified representation of various preferred features illustrative of the basic principles of the invention. The specific design features of the multi-density flexible foam material as disclosed here will be determined in part by the particular intended application and use environment. Certain features of the illustrated embodiments have been enlarged or distorted relative to others to help visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the multi-density flexible foam disclosed here. The following detailed discussion of various alternative and preferred features and embodiments will illustrate the general principles of the invention with reference to a headrest suitable for use in automotive applications. Other embodiments suitable for other applications will be readily apparent to those skilled in the art given the benefit of this disclosure.

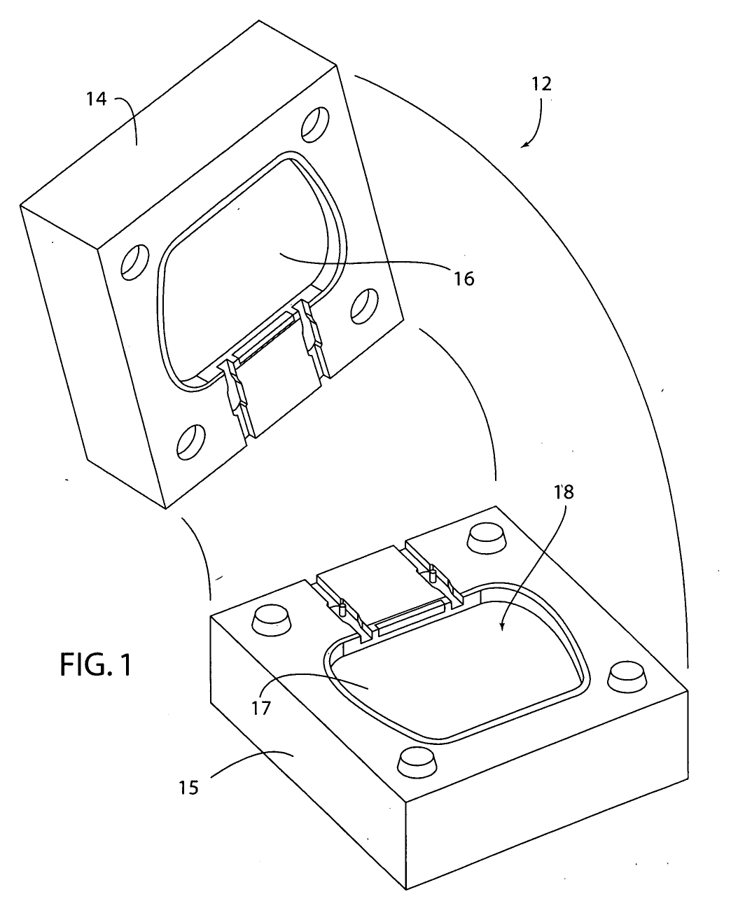

Broadly, manufacture of a flexible foam part involves combining a reactive two component mixture in a mold. These flexible foam parts can comprise automotive headrests, slab stock for bedding and other furniture, viscoelastic polyurethane foams which may be used for pillows or seat cushioning, other consumer and automotive foam products, etc. FIG. 1 shows a representative example of an open mold 12 adapted to receive the two component mixture. The halves 14, 15 of the mold 12 have corresponding mold surfaces 16, 17 which can be closed together and cooperate to define a mold cavity 18 which corresponds to the shape of the part to be molded, here, an automotive headrest 10. A cured polyurethane foam part is formed by reaction of two components: a polyol mixture containing at least one polyol and an isocyanate mixture comprising isocyanate are introduced together into the mold cavity 18. The components react exothermically and quickly foam to fill the mold cavity. A frame 12, often a metal frame, is used which operatively connected the headrest to a motor vehicle seat assembly. The frame is surrounded by the foam.

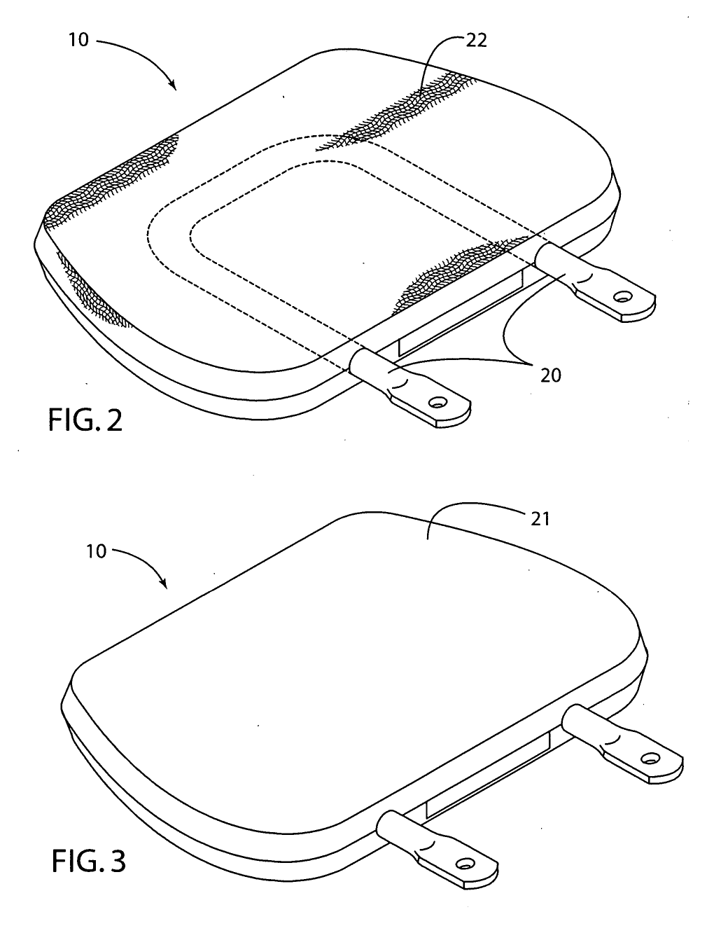

The headrest 10 may be formed with a cloth, fabric, vinyl or leather covering 14 as shown in FIG. 2. The covering may be assembled after the foam cured, or before, as would be the case with a pour-in-place mold. Optionally urethane paint 21 may be applied to the mold prior to reaction of the two components. The polyol mixture and isocyanate mixture react behind the paint to form an integral skin foam part as shown in FIG. 3.

Typically the polyol mixture comprises a polyol such as a triol, surfactants (to help reduce surface tension of the fluid), catalysts (to accelerate the reaction) and sometimes water and/or a blowing agent. Other ingredients of the polyol mixture can comprise, for example: graft copolymer polyols, cell openers, cross-linkers, fillers, colorants, flame retardants, plasticizers, bacteriostats, UV stabilizers, antistatic agents. The polyol mixture can be formed as a single mixture. Alternatively, as is the case with some slab stock materials and seating applications, some of the components of the polyol mixture may be formed as a slurry or as separate ingredients metered in separate streams. Other materials suitable for use in a polyol mixture will be readily apparent to those skilled in the art given the benefit of this disclosure.

Typically the isocyanate mixture comprises an isocyanate such as TDI or MDI. For flexible foam polyurethanes, if 100 parts by weight of a polyol mixture are used, then typically 20-100 parts by weight of the isocyanate mixture are used.

A multi-density foam material is formed from addition to a closed mold of expandable beads to the flexible foam material formed from reaction of a polyol mixture with an isocyanate. As the reaction takes place, heat is generated, typically for reaction injection molded polyurethanes commonly used in automotive applications—in the range of about 205-265° F., most typically about 225° F. near the center of the part. This heat causes gas trapped in the expandable beads to be released, expanding the volume of the bead. However, in accordance with a highly advantageous feature, the mold cavity is cooler near its edges. Depending upon their precise chemistry, the expandable polymer beads typically start to significantly expand around 180-220° F., for example, 200° F. Significant expansion here is understood to mean greater than 20% expansion over the size of the expandable beads at ambient conditions, or about 70° F. Typically expansion of the expandable beads follows a generally sigmoidal curve with temperature increase so that relatively discrete layers with different densities are formed. Expansion is typically associated with a bursting of external walls of the beads as the trapped gas seeks to escape. Preferably the mold is only heated to a temperature less than the temperature at which the expandable polymer beads begin significant expansion, about 110-170° F., most typically about 140° F. Some heating of the mold is preferred to ensure good properties (such as complete reaction of the polyol mixture and the isocyanate). It will be readily apparent to those skilled in the art, given the benefit of this disclosure, that higher temperature foams (such as some slab stock) may be used with beads which expand at higher temperatures.

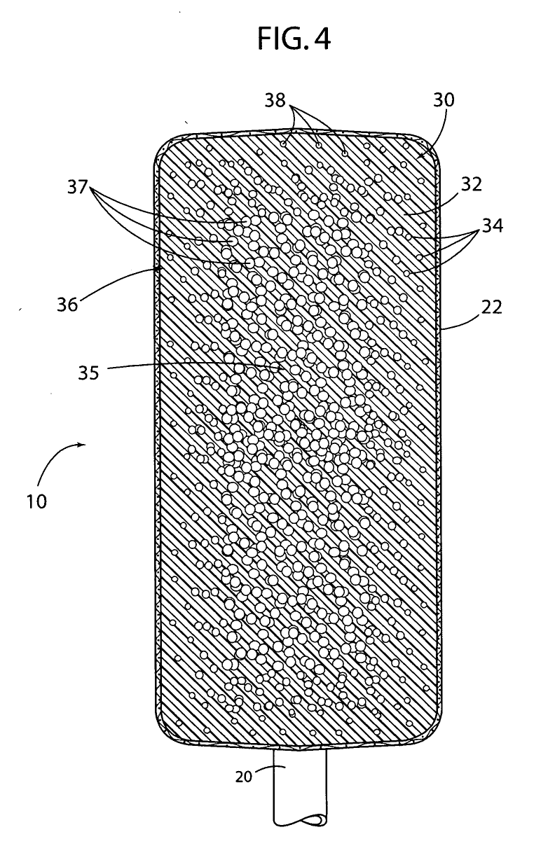

Controlling the temperature of the mold helps regulate the size that the polymer beads can expand to and helps to determine the depth of the edge layer of the material. Heating the mold also helps to ensure acceptable surface characteristics in the finished part. A cross section through such a part shows a matrix of cured polyurethane foam with large beads in the center and smaller, less expanded beads around the periphery or edge of the part. FIG. 4 shows the result when the multi-density foam material is used to form a headrest 10. The foam material 30 comprises polyurethane foam 32 and expandable polymer beads 34. The beads 37 in the center 35 have expanded the most, and the beads 38 at the edge 36 have expanded the least. As the beads (even the expanded beads) are denser than the polyurethane foam, the effect is to create a part having a first density in the center 35 and a second density less than the first density at the edge 36. When the part is a headrest, the effect is a soft exterior which is comfortable and which make its easier to attached covering. A harder interior which helps reduce the chances of whiplash in some instances and can help pass stringent automotive seat regulations, such as FMVSS 202A, parts 2.6 and 2.7. Parts made with the current invention typically have an Indentation Force Deflection (IFD), which is a measure of the load bearing capacity of flexible polyurethane foam which is greater near the center of the part than at the edge. IFD is generally measured as the force (in pounds or Newtons) required to compress a 50 square inch circular indentor foot into a four inch thick sample no smaller than 15 inches square, to a stated percentage of the sample's initial height. Common IFD values for flexible foam polyurethane parts are generated at 25 and 65 percent of initial height. Materials that are suitable for use as the expandable beads comprise unexpanded and partially expanded polymers such as polypropylenes, polyolefins, polystyrenes, polyethylenes, combinations thereof, etc. Other materials suitable for use as expandable beads will be readily apparent to those skilled in the art given the benefit of this disclosure.

Preferably unexpanded expandable beads having a diameter of about 0.1 to 6 mm may be used, most preferably about 0.4 mm. Also, it has been found that a preferably range of such expandable beads is 0.1 to 1.5 parts by weight of the polyol mixture. Use of this range of amount of beads with polyol mixtures and isocyanate mixtures has been found to create multi-density cured polyurethane foams. Other two component polyol/isocyanate mixtures which work with the expandable beads discussed herein will be readily apparent to those skilled in the art given the benefit of this disclosure. For example, a suitable viscoelastic foam used to make seat cushions and automotive parts which can incorporate expandable polymeric beads is the Bayfit 582 system, supplied by Bayer Automotive.

As the reaction between the polyol mixture and the isocyanate mixture is fairly rapid, it is preferably to premix the expandable beads with either the polyol mixture or the isocyanate mixture, or both. Where beads are added to both mixtures, larger amounts of bead may be used, as much as 1.2-1.5 parts by weight of the polyol mixture. For example, 0.75 parts may be added to the polyol mixture and 0.75 parts added to the isocyanate mixture.

### EXAMPLE 1

An integral skin foam flexible polyurethane part can be made by applying a polyurethane paint (free of expandable polymeric beads) to a mold, and then injecting two reactants; the first reactant is 100 parts by weight of a polyol mixture (comprising largely a polyol) and 50 parts by weight of polypropylene beads, or 0.5 parts by weight of the polyol, average diameter unexpanded: 0.4 mm. The second reactant is an isocyanate mixture, comprising largely an isocyanate, 40 parts by weight, or 0.4 parts by weight of the polyol. Typically little or no water is used for such integral skin flexible foam parts. Water substitutes may be used as a blowing agent, e.g., ethylene glycol, carbamides, and other commercially available blowing agents, if needed. The polyols and isocyanates can be supplied as system (where one supplier provides a premixed polyol mixture containing polyol and some other ingredients, and separately a premixed isocyanate mixture, most typically comprising largely isocyanate) by any one of numerous sources, including the Bayflex system from Bayer. Although 50 parts by weight is most preferred, smaller amounts such as 10-20 parts have also been found to produce acceptable multi-density parts.

### EXAMPLE 2

A flexible foam polyurethane part without an integral skin is formed from combining a first mixture and a second mixture. The first mixture comprises a polyol mixture comprising 100 parts by weight of a polyol mixture, 4.5 parts by weight water, mixed with 100 parts by weight polypropylene beads, average diameter (unexpanded) of about 0.4 mm. The second mixture comprises an isocyanate mixture of about 75 parts by weight, mixed with the first mixture in a mold. The reaction is exothermic and foam generating, and causes the foam to expand (both polyurethane and expandable beads) to fill the mold. These polyol mixtures and isocyanate mixtures can be supplied as the Bayfit system from Bayer or the Rubiflex/Rubinate system supplied by Huntsman. The polyol mixture and isocyanate mixture may be blended together at the site of production of the foam part.

### EXAMPLE 3

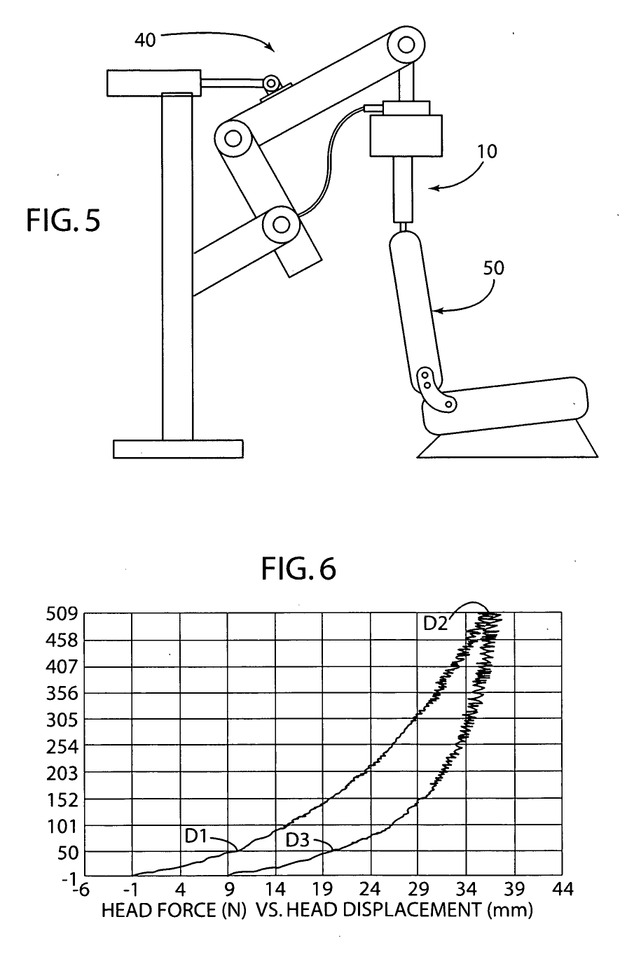

Automotive headrests made using the multi-density flexible foam are advantageous in that they can pass newer, more stringent tests designed to simulate a head or other object hitting a headrest and a rear impact in a motor vehicle, such as FMVSS 202A S5.2.6 (for height retention) and S5.2.7 (backset retention, strength and displacement). FIG. 5 shows a simplified schematic of a test fixture 40 designed to apply a load to a headrest 10 affixed to a motor vehicle seat assembly 50. As shown, the fixture is set for the height retention test. The multi-density foam material comprises 100 pts of a polyol mixture, 55 parts by weight polystyrene beads, and 41 parts by weight isocyanate mixture, with the polyol mixture and isocyanate mixture supplied by Bayer.

In the height retention test, the headrest begins in an uncompressed position, and is subjected to a load simulating hitting the headrest, comprising gradually applying a vertical load straight down from the headrest toward the seat assembly as shown in FIG. 5, deflecting and compressing the headrest at the point of contact. When the load reached 50 N, the amount of deflection was measured as D1=10.4 mm. Deflection reflects the amount the headrest is compressed by the load. This D1 measurement is significantly less than the maximum allowable test specification deflection of D1 less than 25 mm. The load is held for 5 seconds, then the test fixture continues to increase the load until it reaches 500 N, is again held for 5 seconds (where a deflection D2 is measured), and then gradually reduces the load until it returns to 50 N. The deflection D3 is again measured. The difference between the deflection at this instant, D3 and the D1 deflection, is the height retention, and was measured as 9.7 mm, again significantly less than the test specification of less than 13 mm. FIG. 6 shows a graph of loading vs. displacement during this cycle. The entire test takes about 250 seconds.

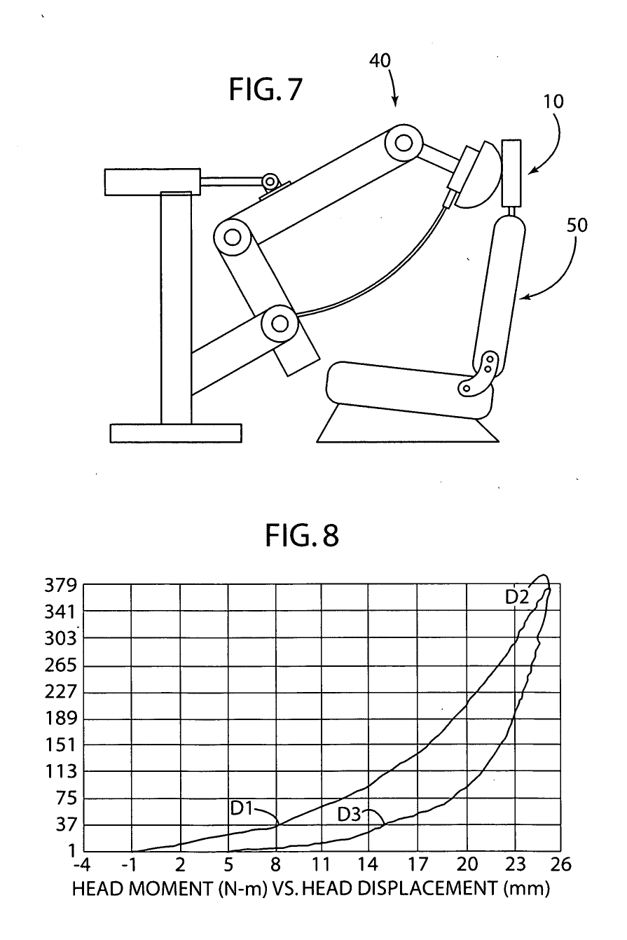

FIG. 7 shows the test fixture 40 applying a load at an angle with respect to the headrest 10, generating a moment on the headrest and on the seat assembly 50 to which it is attached. As shown, the test fixture is set for the backset retention, strength and displacement test, and the angle is about 25 degrees between vertical and a torso reference line. Vertical is understood here to refer to the upward direction with reference to the seat assembly. The precise angle varies somewhat depending on the size of the seat assembly and the seat's H-point (distance between the hip and the ground or floor), but is generally 20-30 degrees from vertical. The headrest comprises the same material as was used in the height retention test. Load is gradually applied until a torso moment of 37 N-m (50 N direct loading) is reached, and deflection of the headrest D1 is measured as 8.2 mm. This is significantly less than the maximum allowable test specification deflection of D1 less than 25 mm. The test fixture continues to increase the torso moment until it reaches 373 N-m (500 N direct loading), deflection D2 is measured, and then gradually reduces the load until it returns to 37 N-m. The difference between the deflection now, D3, and the D1 deflection, or backset retention, was 7.2 mm, again significantly less than the test specification of less than 13 mm. FIG. 8 shows a graph of torque loading vs. displacement in this test cycle. As with the height retention test, the load is held for 5 seconds at the initial torso moment, and again held for 5 seconds at the maximum torso moment. The entire test takes about 250 seconds.

The results of these two tests are significant. The new foam material disclosed herein used for a headrest allows the headrest to pass these two tests without relatively expensive modifications, such as modifying the frame or the seat assembly or the addition of a stiff inner filler.

The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A multi-density foam material comprising, in combination:
a polyol mixture;
an isocyanate mixture combined with the polyol mixture; and
expandable beads;
wherein the polyol mixture and the isocyanate mixture react exothermically to form a flexible foam, and heat generated from the reaction causes the expandable beads to at least partially expand;
wherein the foam material has a center with a first density, and an exterior edge with a second density different than the first density.

2. The multi-density foam material of claim 1 wherein the polyol mixture comprises at least one polyol and water.

3. The multi-density foam material of claim 1 wherein the expandable beads have, when unexpanded, an average diameter of about 0.4 mm.

4. The multi-density foam material of claim 1 wherein the beads are added to one of the polyol mixture and the isocyanate mixture prior to mixing the polyol mixture and the isocyanate mixture together.

5. The multi-density foam material of claim 1 wherein the expandable beads comprise one of an expandable polypropylene, an expandable polyolefin, an expandable polystyrene, and an expandable polyethylene.

6. The multi-density foam material of claim 1 further comprising a metal frame, wherein the foam is formed around the frame.

7. The multi-density foam material of claim 1 wherein the flexible foam is a viscoelastic foam.

8. The multi-density foam material of claim 1 wherein the edge has a density less than the density at the center.

9. The multi-density foam material of claim 1 further comprising an integral skin comprising a urethane paint.

10. The multi-density foam material of claim 1 wherein the foam material forms a headrest.

11. The multi-density foam material of claim 10 wherein the headrest is attached to a seat assembly and a load is applied in a direction from the headrest toward the seat assembly for about 250 seconds in the following manner:
applying a load of 50 N and measuring a deflection of the headrest as the difference between a compressed headrest and non-compressed headrest, D1;
holding the load of 50 N on the headrest for 5 seconds;
gradually increasing the load to 500 N and holding at this level for 5 seconds;
gradually decreasing the load back to 50 N, measuring a deflection, D3 and comparing a height retention as the difference between the deflection D3 and the first deflection D1; and
D1 is less than 25 mm, and the height retention is less than 13 mm.

12. The multi-density foam material of claim 10 wherein the headrest is attached to a seat assembly and a load is applied at an angle of about 25 degrees from vertical for about 250 seconds in the following manner:
applying a load of 50 N and measuring a deflection of the headrest as the difference between a compressed headrest and an uncompressed headrest, D1 and holding the load at this level for 5 seconds;
gradually increasing the load to 500 N and holding at this level for about 5 seconds;
gradually decreasing the load back to 50 N, measuring a deflection, D3 and comparing a backset retention as the difference between the deflection D3 and the first deflection D1; and
D1 is less than 25 mm and the backset retention is less than 13 mm.

13. The multi-density foam material of claim 1 wherein the isocyanate mixture is combined with the polyol mixture in a ratio of about 0.2 to 1.0 parts by weight of the polyol mixture, and the expandable beads are added to the polyol mixture in an amount of about 0.1 to 1.5 parts per weight of the polyol mixture.

14. A method of making a multi-density foam material having a center and an edge comprising, in combination, the steps of:
mixing a polyol mixture, an isocyanate mixture and expandable beads in a mold, wherein the polyol mixture reacts exothermically with the isocyanate mixture to generate sufficient heat to expand the expandable beads at the center, and the edge is at a temperature below that where significant expansion of the expandable beads occurs, such that the resulting foam material has a first density at the center and second density at the edge different than the first density.

15. The method of claim 14 wherein center is heated to about 205-265° F., and the expandable polymer beads expand around 180-220° F.

16. The method of claim 14 wherein the mold is heated to about 110-170° F.

17. The method of claim 14 wherein the density of the edge is less than the density of the center.
